(19) United States
(12) Patent Application Publication
(10) Pub. No.: US 2020/0272424 A1
(43) Pub. Date: Aug. 27, 2020

(54) METHODS AND APPARATUSES FOR CACHELINE CONSCIOUS EXTENDIBLE HASHING

(71) Applicant: RESEARCH & BUSINESS FOUNDATION SUNGKYUNKWAN UNIVERSITY, Suwon-si (KR)

(72) Inventor: Beomseok NAM, Seoul (KR)

(73) Assignee: RESEARCH & BUSINESS FOUNDATION SUNGKYUNKWAN UNIVERSITY, Suwon-si (KR)

(21) Appl. No.: 16/787,318

(22) Filed: Feb. 11, 2020

(30) Foreign Application Priority Data
Feb. 21, 2019 (KR) 10-2019-0020794
Dec. 11, 2019 (KR) 10-2019-0165111

(51) Int. Cl. G06F 7/74; H04L 9/06; G06F 9/38; G06F 16/901

(52) U.S. Cl. CPC G06F 7/74; H04L 9/0643; G06F 16/9017; G06F 16/9027; G06F 9/3816

(57) ABSTRACT

The present disclosure is related to a method and apparatus for cacheline conscious extendible hashing. A method for cacheline conscious extendible hashing according to one embodiment of the present disclosure comprises identifying a segment referenced through a directory by using a first index of a hash key, identifying a bucket to be accessed within the identified segment by using a second index of the hash key, and storing data corresponding to the hash key in the identified bucket.

### CROSS-REFERENCE TO RELATED APPLICATIONS

This application claims priority to Korean Patent Application No. 10-2019-0020794 filed on 21 Feb. 2019 and Korean Patent Application No. 10-2019-0165111 filed on 11 Dec. 2019 in Korea, the entire contents of which are hereby incorporated by reference in their entirety.

### BACKGROUND

### 1. Technical Field

The present disclosure relates to a methods and apparatuses for cacheline-conscious extendible hashing.

### 2. Description of Related Art

Most existing data structures have been designed to be suitable for reading and writing pages in units of 4 KB or 8 KB. As in-memory based database systems such as the SAP HANA database began to be used recently, interests are growing in the data structures which allow for reading and writing data in units of 8 bytes rather than block-based data structures. An advantage of hash table data structures over B-tree data structures is that the hash table data structures take constant time for reading and writing data.

A hash table uses a hash function to determine a specific location at which data is stored, and the space which stores data having a specific hash key value is called a bucket. Hash tables may be largely divided into two types. One is the static hash table, and the other is the dynamic hash table. A static hash table data structure requires a single, large contiguous memory space. In other words, buckets for storing data are arranged in one memory space contiguously one after another. If a hash key value of some data is K, the value is stored in the K-th bucket, where the location of the K-th bucket is determined by (K×bucket size) in the contiguous memory space. In other words, if the bucket size is 4 KB, and a hash key value is 3, data has to be stored into a bucket located 12 KB away in the contiguous memory space allocated for a hash table. If some data has found a bucket into which the data is to be stored, but the bucket already contains a large amount of data to accommodate the new data, a static hash table allocates contiguous memory space larger than the current memory space and copies existing data into buckets allocated in the new memory space. This operation is called rehashing, which causes very large overhead.

FIG. 1 illustrates the legacy extendible hashing data structure.

To reduce the rehashing overhead, dynamic hash tables, in which buckets are dynamically allocated, have been developed. The most representative method uses extendible hashing. As shown in FIG. 1, the structure of an extendible hash table consists of two layers. The upper layer is a pointer array, called a directory, and the lower layer is composed of buckets for storing data. Last or first few bits of a hash key of data to be stored are used to determine which directory entry to read. The number of bits for this purpose is determined by the directory size. As shown in the example of FIG. 1, if the directory size is 4 (2²), only two bits are used; if the directory size is 8 (2³), three bits are used. The example of FIG. 1 uses two bits. Since the two least significant bits (LSBs) are 10₍₂₎, a bucket is determined by the directory entry corresponding to the binary number 10₍₂₎ among the four directory entries, namely, the third pointer whose array index is 2.

In the example of FIG. 1, bucket B3 is used. The number of bits used to determine a directory entry is called global depth, G, for the directory. Each individual bucket has its own local depth, because a single bucket may be pointed to by multiple directory entries. As shown in the example of FIG. 1, the bucket B2, which has the global depth of 2 and local depth of 1, is pointed to by two directory entries. If the global depth is 3, and the local depth is 1, the bucket may be pointed to by 2 (3−1) directory entries.

As shown in FIG. 1, if new data are attempted to be stored in the bucket B2, but storage space is not sufficient, two new buckets have to be created to split and store the data therein. Since the bucket B2 of FIG. 1 has a local depth of 1, data have been stored in the bucket B2 by using only one bit indicated in dark black color. If the bucket is split, however, the local depth is incremented by one to create two buckets B4 and B5, which have a local depth of 2, as shown in FIG. 2.

FIG. 2 illustrates a split example in the legacy extendible hashing scheme.

Data stored in a bucket with insufficient space are copied to a first new bucket, B4, or a second new bucket, B5, according to the increased local depth, namely, a two-bit value. Data whose low end 2 bits are 01₍₂₎ are copied to a first newly created bucket B4, and data whose low end 2 bits are 11 are copied to a second newly created bucket B5. After the split operation, directory entries pointing to the bucket B2 are updated. That is, the directory entry 01₍₂₎ is updated to point to the new bucket B4 storing data corresponding to 01₍₂₎ while the directory entry 11₍₂₎ is updated to point to the new bucket B5 storing data corresponding to 11₍₂₎.

FIG. 3 illustrates an example of directory extension according to extendible hashing.

If the local depth and the global depth are K, the bucket is pointed to by only one directory entry. Suppose the bucket B3 in the example of FIG. 2 is split. The local depth of the bucket B3 is 2 (Local depth=2), and the global depth for directory is also 2 (G=2). In this case, if the bucket B3 is split to create new buckets B6 and B7 having a local depth of 3, data are copied to B6 or B7 by using as many bits as the local depth. In other words, 1101 . . . 10001010₍₂₎ stored in the bucket B3 is copied to bucket B6 corresponding to the low end 3 bits, 010₍₂₎, and 010 . . . 01101110₍₂₎ is copied to bucket B7 corresponding to 110₍₂₎. However, it is not possible to store a pointer pointing to the new buckets B6 and B7 in the directory. Therefore, if a bucket is split when the local depth and the global depth are the same with each other, the directory needs to be doubled as shown in FIG. 3. This operation is called directory doubling. In other words, a directory having a global depth of 3 (2³) and capable of storing 8 directory entries is newly created. At this time, pointers for other unsplit buckets are copied, and the unsplit buckets are doubly pointed to by new directory entries. In other words, bucket B1 pointed to by 00 is pointed to not only by the directory entry 000₍₂₎ but also by the directory entry 100₍₂₎.

The extendible hashing described above is used by various file systems including the Oracle ZFS. However, since the bucket size is fixed to 4 KB or 8 KB, its performance is optimized only for disk-based systems. In other words, the extendible hashing is not suitable for the data structure of an in-memory system. If the extendible hashing is directly applied to the in-memory system, a bucket needs to be determined through the directory, and all the data stored within the bucket have to be read out one by one. Also, in order to be used for byte-addressable and non-volatile memories such as the Intel 3D Xpoint, Spin Transfer Torque-Magnetic Random Access Memory (STT-MRAM), and Phase-change memory (PCRAM), which are currently under development, a data structure should always guarantee consistency even if the data structure is updated by 8-byte operations. However, the legacy extendible hashing schemes have a problem that they fail to guarantee consistency for the 8-byte operations.

### SUMMARY

Exemplary embodiments according to the present disclosure attempt to provide a method and apparatus for cacheline conscious extendible hashing capable of minimizing the number of cacheline accesses by using a segment having at least one bucket referenced through a directory.

Exemplary embodiments of the present disclosure attempt to provide a method and apparatus for cacheline conscious extendible hashing capable of guaranteeing failure-atomicity which was not provided for non-volatile memories by the legacy extendible hashing schemes and utilizing non-volatile memories more efficiently with a smaller number of cacheline accesses.

According to one example embodiment of the present disclosure, a method for cacheline conscious extendible hashing performed by apparatus for cacheline conscious extendible hashing, the method may comprise identifying a segment referenced through a directory by using a first index of a hash key; identifying a bucket to be accessed within the identified segment by using a second index of the hash key; and storing data corresponding to the hash key in the identified bucket.

The method may further comprise checking global depth bits of the hash key.

The first index of the hash key may include the most significant bit (MSB) of the hash key.

The second index of the hash key may include the least significant bit (LSB) of the hash key.

The identifying a segment may search for a directory entry corresponding to the first index of the hash key and identify a segment referenced through the searched directory entry.

The method may further comprise splitting a segment if collision occurs when the segment is accessed by using the second index of the hash key.

The splitting a segment may create a new segment having an increased local depth and by scanning data of the identified segment, copy the data having a preconfigured bit value corresponding to the increased local depth into the newly created segment.

The splitting a segment may increase the local depth of the split segment and designate the data having a preconfigured, different bit value corresponding to the increased local depth as an invalid key.

The splitting a segment may increase the local depth of the identified segment, update a pointer of a directory entry, and increase the local depth of the split segment.

If the segment is split, the method may further comprise grouping directory entries into buddy pairs when the directory is updated.

The method may further comprise identifying a segment exhibiting a system problem by using a global and local depths of the segment and recovering the segment exhibiting the system problem by using the buddy.

Meanwhile, according to another example embodiment of the present disclosure, apparatus for cacheline conscious extendible hashing may comprise a memory storing at least one program and a segment including at least one bucket referenced through a directory; and a processor connected to the memory through a cache, wherein the processor is configured to execute the at least one program to identify a segment referenced through a directory by using a first index of a hash key, identify a bucket to be accessed within the identified segment by using a second index of the hash key, and write or read data corresponding to the hash key to or from the identified bucket.

The processor may further comprise checking global depth bits of the hash key.

The first index of the hash key may include the most significant bit (MSB) of the hash key.

The second index of the hash key may include the least significant bit (LSB) of the hash key.

The processor may search for a directory entry corresponding to the first index of the hash key and identify a segment referenced through the searched directory entry.

The processor may split a segment if collision occurs when the segment is accessed by using the second index of the hash key.

The processor may create a new segment having an increased local depth and by scanning data of the identified segment, copy the data having a preconfigured bit value corresponding to the increased local depth into the newly created segment.

The processor may increase the local depth of the split segment and designate the data having a preconfigured, different bit value corresponding to the increased local depth as an invalid key.

The processor may increase the local depth of the identified segment, update a pointer of a directory entry, and increase the local depth of the split segment.

If the identified segment is split, the processor may group directory entries into buddy pairs when the directory is updated.

The processor may identify a segment exhibiting a system problem by using a global and local depths of the segment and recover the segment exhibiting the system problem by using the buddy.

Meanwhile, according to another example embodiment of the present disclosure, in a non-volatile, computer-readable storage medium including at least one program that may be executed by a processor, a non-volatile, computer-readable storage medium includes commands driving the processor to identify a segment referenced through a directory by using a first index of a hash key, identify a bucket to be accessed within the identified segment by using a second index of the hash key, and insert a key value corresponding to the hash key into the identified bucket when the at least one program is executed by the processor.

The embodiments of the present disclosure may minimize the number of memory cacheline accesses by using a segment including at least one bucket referenced through a directory.

The embodiments of the present disclosure may provide failure-atomicity which was not provided for non-volatile memories by the legacy extendible hashing schemes and utilize non-volatile memories more efficiently with a smaller number of cacheline accesses.

### BRIEF DESCRIPTION OF THE DRAWINGS

FIG. 1 illustrates the legacy extendible hashing data structure.

FIG. 2 illustrates a split example in the legacy extendible hashing scheme.

FIG. 3 illustrates an example of directory extension according to extendible hashing.

FIG. 4 illustrates a structure of apparatus for cacheline conscious extendible hashing according to one embodiment of the present disclosure.

FIGS. 5 to 7 illustrate operations of apparatus for cacheline conscious extendible hashing according to one embodiment of the present disclosure.

FIG. 8 is a flow diagram illustrating a cacheline conscious extendible hashing operation according to one embodiment of the present disclosure.

FIG. 9 illustrates an operation for creating a new segment in a cacheline conscious extendible hashing operation according to one embodiment of the present disclosure.

FIG. 10 illustrates a split and lazy deletion operation in a cacheline conscious extendible hashing operation according to one embodiment of the present disclosure.

FIGS. 11 to 13 illustrate a tree-form segment split operation in a cacheline conscious extendible hashing operation according to one embodiment of the present disclosure.

FIG. 14 illustrates a pseudo code of a recovery algorithm according to one embodiment of the present disclosure.

FIG. 15 is a flow diagram illustrating an insertion operation in a method for cacheline conscious extendible hashing according to one embodiment of the present disclosure.

FIG. 16 is a flow diagram illustrating a split operation in a method for cacheline conscious extendible hashing according to one embodiment of the present disclosure.

FIG. 17 is a flow diagram illustrating a recovery operation in a method for cacheline conscious extendible hashing according to one embodiment of the present disclosure.

FIGS. 18A to 18C illustrate an experimental result of throughput with varying segment/bucket sizes between an embodiment of the present disclosure and the legacy method.

FIGS. 19A to 19D illustrate time spent for insertion with varying R/W latency of a non-volatile memory between an embodiment of the present disclosure and the legacy method.

FIGS. 20A to 20C illustrate performance of concurrent execution indicated by latency CDFs and insertion/search throughput between an embodiment of the present disclosure and the legacy method.

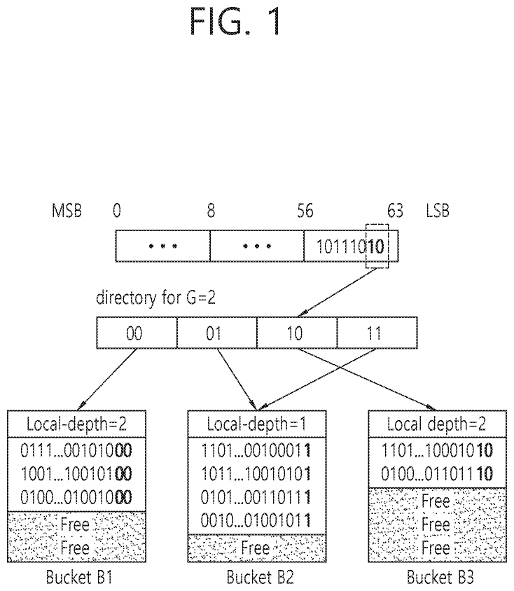

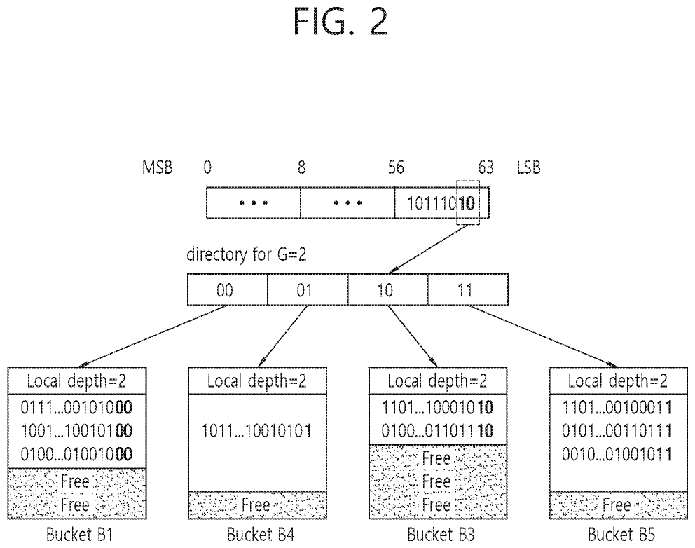

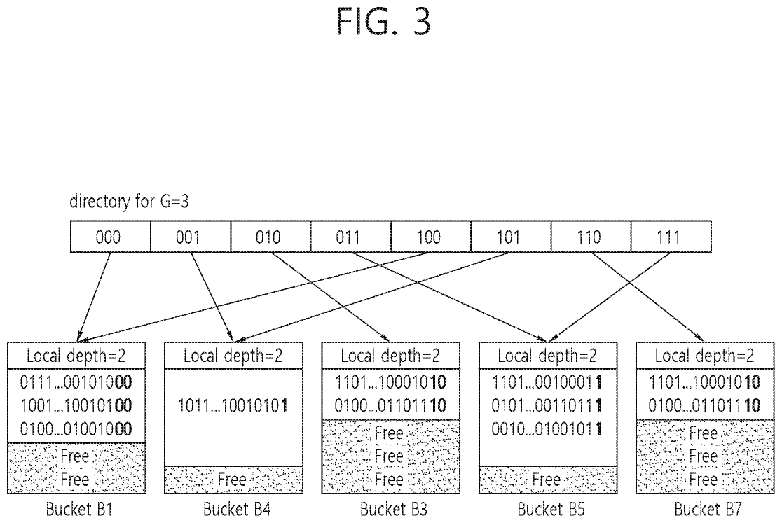

### DETAILED DESCRIPTION OF EXAMPLE EMBODIMENTS

Since the present disclosure may be modified in various ways and may provide various embodiments, specific embodiments will be depicted in the appended drawings and described in detail with reference to the drawings.

However, it should be understood that the specific embodiments are not intended to restrict the gist of the present disclosure to the specific embodiments; rather, it should be understood that the specific embodiments include all of the modifications, equivalents or substitutes described by the technical principles and belonging to the technical scope of the present disclosure.

Terms such as first or second may be used to describe various constituting elements, but the constituting elements should not be restricted by the terms. Those terms are used only for the purpose of distinguishing one constituting element from the others. For example, without departing from the technical scope of the present disclosure, a first constituting element may be called a second constituting element and vice versa. The term and/or includes a combination of a plurality of related, disclosed items or any one of a plurality of related, disclosed items.

If an element is said to be “connected” or “attached” to other element, the former may be connected or attached directly to the other element, but there may be a case in which another element is present between the two elements. On the other hand, if an element is said to be “directly connected” or “directly attached” to other element, it should be understood that there is no other element between the two elements.

Terms used in this document are intended only for describing a specific embodiment and are not intended to limit the technical scope of the present disclosure. A singular expression should be understood to indicate a plural expression unless otherwise explicitly stated. The term of “include” or “have” is used to indicate existence of an embodied feature, number, step, operation, element, component, or a combination thereof; and should not be understood to preclude the existence or possibility of adding one or more other features, numbers, steps, operations, elements, components, or a combination thereof.

Unless defined otherwise, all of the terms used in this document, including technical or scientific terms, provide the same meaning as understood generally by those skilled in the art to which the present disclosure belongs. Those terms defined in ordinary dictionaries should be interpreted to have the same meaning as conveyed by a related technology in the context. And unless otherwise defined explicitly in the present disclosure, those terms should not be interpreted to have ideal or excessively formal meaning.

In what follows, with reference to appended drawings, preferred embodiments of the present disclosure will be described in more detail. In describing the present disclosure, to help overall understanding, the same reference symbols are used for the same elements in the drawings, and repeated descriptions of the same elements will be omitted.

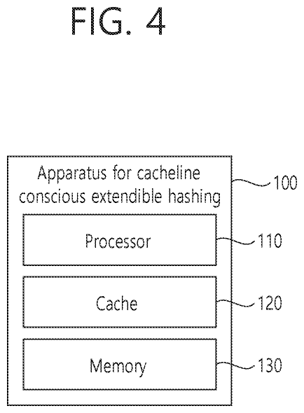

FIG. 4 illustrates a structure of apparatus for cacheline conscious extendible hashing according to one embodiment of the present disclosure.

As shown in FIG. 4, apparatus 100 for cacheline conscious extendible hashing according to one embodiment of the present disclosure comprises a processor 110, a cache 120, and a memory 130. However, not all of the illustrated constituting elements are essential. The apparatus 100 for cacheline conscious extendible hashing may be implemented by using a larger number of constituting elements than illustrated, and the apparatus 100 for cacheline conscious extendible hashing may also be implemented by using a fewer number of constituting elements than illustrated.

In what follows, a detailed structure and operations of each constituting element of the apparatus 100 for cacheline conscious extendible hashing will be described.

The memory 130 stores at least one program. The memory 130 may include a file system or a database. The memory 130 stores a segment including at least one bucket referenced through a directory. Here, the memory 130 may be a non-volatile memory (NVM, NVRAM) or a volatile memory.

The processor 110 is connected to the memory 130 through the cache 120. Through a cacheline of the cache 120, the processor 110 may store data into a bucket in the file system of the memory or read data stored in the bucket.

By executing at least one program, the processor 110 identifies a segment referenced through a directory by using a first index of a hash key, identifies a bucket to be accessed within the identified segment by using a second index of the hash key, and stores data corresponding to the hash key into the identified bucket. Here, the processor 110 may directly access one of a plurality of buckets within the segment by using the second index of the hash key.

In various embodiments, the processor 110 may check global depth bits of a hash key.

In various embodiments, the first index of the hash key may include the most significant bit (MSB) of the hash key.

In various embodiments, the second index of the hash key may include the least significant bit (LSB) of the hash key.

In various embodiments, the processor 110 may search for a directory entry corresponding to the first index of the hash key and identify a segment referenced through the searched directory entry.

In various embodiments, the processor 110 may split a segment if collision occurs when the segment is accessed by using the second index of the hash key.

In various embodiments, the processor 110 may create a new segment having an increased local depth and by scanning data of the identified segment, copy the data having a preconfigured bit value corresponding to the increased local depth into the newly created segment. As one example, the processor 110 may copy the data where the bit value of the second index corresponding to the increased local depth is 1 into a new segment and update a pointer of the corresponding directory entry.

In various embodiments, the processor 110 may increase the local depth of a split segment and designate the data having a preconfigured, different bit value corresponding to the increased local depth as an invalid key. As one example, instead of deleting data where a bit value corresponding to the increased local depth of the second index is 0 from the split segment, the processor 110 may designate the undeleted data as an invalid key by increasing only the local depth through an 8-byte operation. In other words, the undeleted data may be considered to be an invalid key and overwritten by other data.

In various embodiments, the processor 110 may increase the local depth of an identified segment, update a pointer of a directory entry, and increase the local depth of a split segment. As one example, the processor 110 may update pointers of directory entries in a descending order starting from a pointer with a large second index value to a pointer with a small second index value. As another example, the processor 110 may update pointers of directory entries in an ascending order starting from a pointer with a small second index value to a pointer with a large second index value. Afterwards, the processor 110 may recover a directory by performing a recovery operation in the opposite direction of the update order.

In various embodiments, if an identified segment is split, the processor 110 may group directory entries into buddy pairs when the directory is updated.

In various embodiments, the processor 110 may identify a segment exhibiting a system problem by using a global and local depths of the segment and recover the segment exhibiting the system problem by using the buddy.

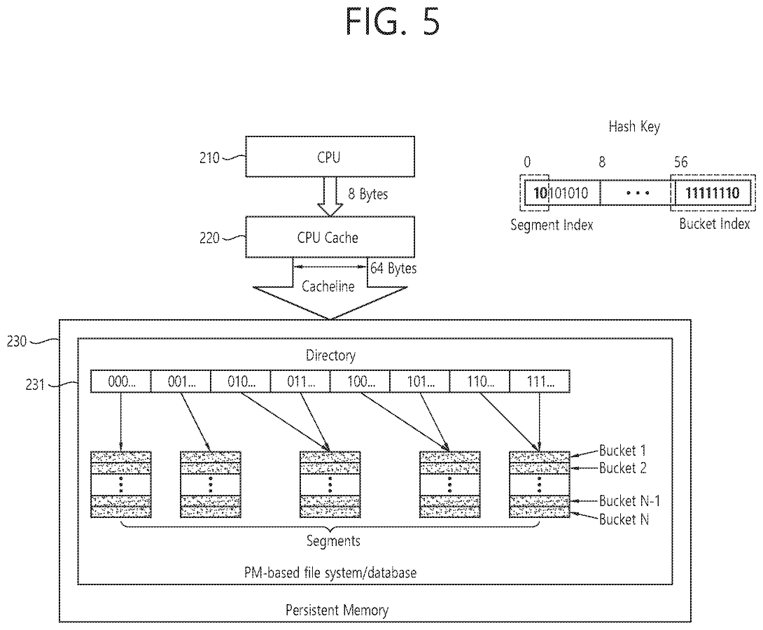

FIGS. 5 to 7 illustrate operations of apparatus for cacheline conscious extendible hashing according to one embodiment of the present disclosure.

The unit of data transfer between a byte-addressable memory and CPU is a 64-bit cacheline in the most recent CPU. If the legacy 8 KB bucket is used, a bucket composed of 128 cachelines needs to be read to find single data, which requires a total of 128 memory accesses. Unlike disk-based extendible hashing schemes, an in-memory hash table doesn't have to make the bucket size fitted to the disk block size. If the bucket size is set to 64 bytes, reading one cacheline suffices to read a single bucket, and thus a total of one memory access is needed.

However, if the bucket size is one cacheline, the directory size becomes very large due to the characteristic of extendible hashing which requires one directory entry for each 64-byte cacheline.

One embodiment of the present disclosure attempts to provide a method for cacheline-conscious extendible hashing (CCEH) suitable for byte-addressable memories by modifying the extendible hashing scheme. The cacheline conscious extendible hashing (hereinafter, CCEH) scheme according to one embodiment of the present disclosure is an extendible hashing method which provides failure-atomicity which was not provided for non-volatile memories by the legacy extendible hashing schemes and enables to utilize non-volatile memories more efficiently with a smaller number of cacheline accesses. The CCEH defines an intermediate layer, which is referred to as a segment, in the legacy two-level structure composed of the directory and buckets, by which cachelines are managed in an efficient manner.

FIG. 5 illustrates an example of operating the apparatus for CCEH according to one embodiment of the present disclosure, including a persistent memory (PM)-based file system or database.

As shown in FIG. 5, the apparatus for CCEH according to one embodiment of the present disclosure includes a CPU 210, a CPU cache 220, and a persistent memory (PM) 230. Here, the PM 230 may include a PM-based file system 231 or a PM-based database. Instead of the PM 230, dynamic random-access memory (DRAM) may be used.

The CPU 210 identifies a directory entry referenced by the index of a hash key through the cacheline of the CPU cache 220 and attempts to access a bucket within a segment pointed to by the corresponding directory entry.

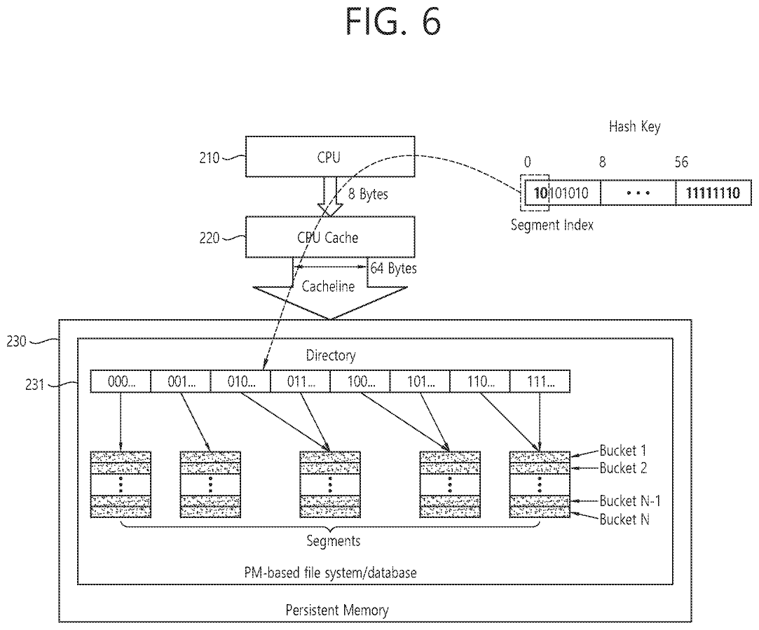

As shown in FIG. 6, the CPU 210 may identify the segment referenced through the directory by using a first index of the hash key. In other words, the CPU 210 may determine which directory entry to reference by using a segment index. Here, the segment index may be called a first index. In the example of FIG. 6, the directory entry 010 (2) is referenced by using a segment index 10 (2) corresponding to the most significant two bits.

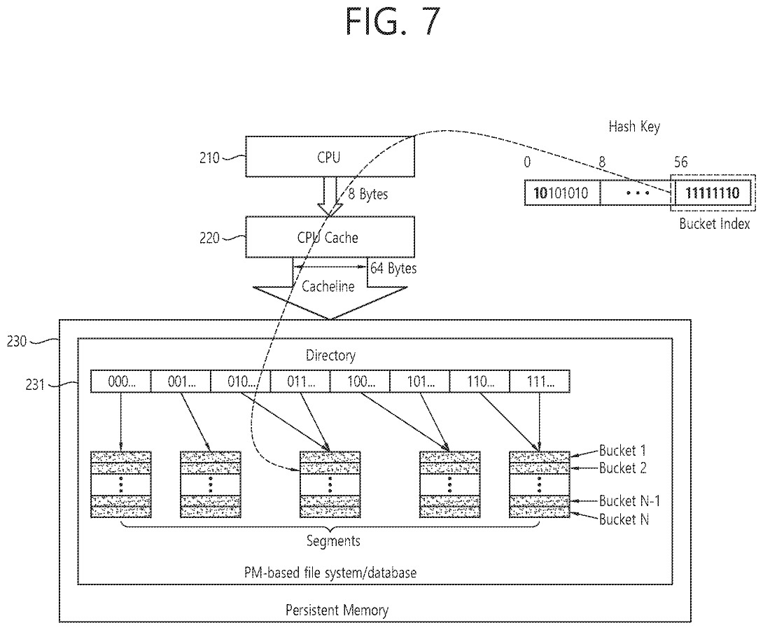

As shown in FIG. 7, the CPU 210 may identify a bucket to be assessed within the identified segment by using the second index of the hash key. To determine which bucket to read within the referenced segment, the CPU 210 may use a bucket index of the hash key. Here, the bucket index may be called a second index. As a result, the CPU 210 may identify a segment through a directory entry referenced by the segment index and identify a bucket pointed to by the bucket index within the identified segment. Directory[segment index] plus bucket index may become the address of a bucket to be accessed. And the CPU 210 may store a key value or data corresponding to the hash key into the identified bucket. Or, the CPU may write or read a key value or data corresponding to the hash key to or from the identified bucket.

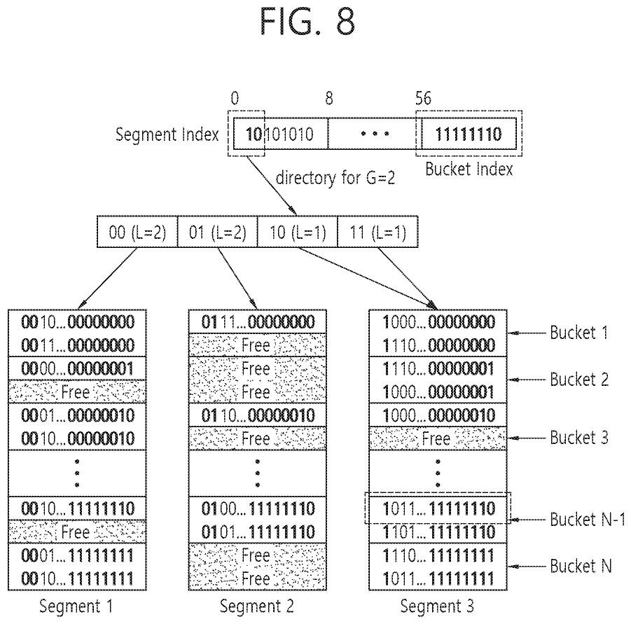

FIG. 8 is a flow diagram illustrating a cacheline conscious extendible hashing operation according to one embodiment of the present disclosure.

A hash table structure according to one embodiment of the present disclosure introduces an intermediate layer, which is referred to as a segment, between the directory and buckets. In other words, a segment is a contiguous memory space for grouping at least one bucket, which is used to reduce the directory size. In other words, rather than directly point to a bucket, the directory points to the start location of a segment and determines which bucket in the segment, namely, which cacheline to read by using other bits of the hash key. In one embodiment of the present disclosure, a segment is determined by using the most significant bits (MSBs) or least significant bits (LSBs) of the hash key, and a bucket within the segment is located by using other bits of the hash key.

To illustrate the example of FIG. 8, since the global depth is 2 (G=2), the directory has 4 (2²) entries, namely, 00 (L=2), 01 (L=2), 10 (L=1), and 11 (L=1). If a given hash key value is 10101010 . . . 11111110₍₂₎, a segment is determined from the directory by using two bits, 10₍₂₎, representing the global depth, namely, the segment index. In the present example, it is assumed that two most significant bits are used. 10₍₂₎ points to segment 3. To locate a bucket inside the segment, other bits of the hash key, namely, a bucket index is used, where the number of bits is determined by the segment size. In other words, if a segment has 2^{S} buckets (cachelines), S bits have to be used. Since it was assumed that a segment is determined by using the most significant bits, least significant bits (LSBs), namely, the bucket index is used to locate a bucket. For example, suppose one segment is composed of 256 (2⁸) cacheline-sized buckets. In this case, a bucket is located by using 8 bits. Since the low end 8 bits of a given hash key value are 11111110₍₂₎, the 254-th cacheline becomes the bucket used for storing or seeking data. In other words, if the hash key is given as 10101010 . . . 11111110₍₂₎, through (&Segment(10₍₂₎)+64*11111110₍₂₎) operation, the memory address of a cacheline to or from which data are stored or read may be determined in one fell swoop. Here, the segment index and bucket index of the hash key are not limited to a specific location.

As described above, the apparatus 100 for CCEH according to one embodiment of the present disclosure may store or read data with only two cacheline accesses. The apparatus 100 for CCEH according to one embodiment of the present disclosure may minimize the number of memory accesses through a segment.

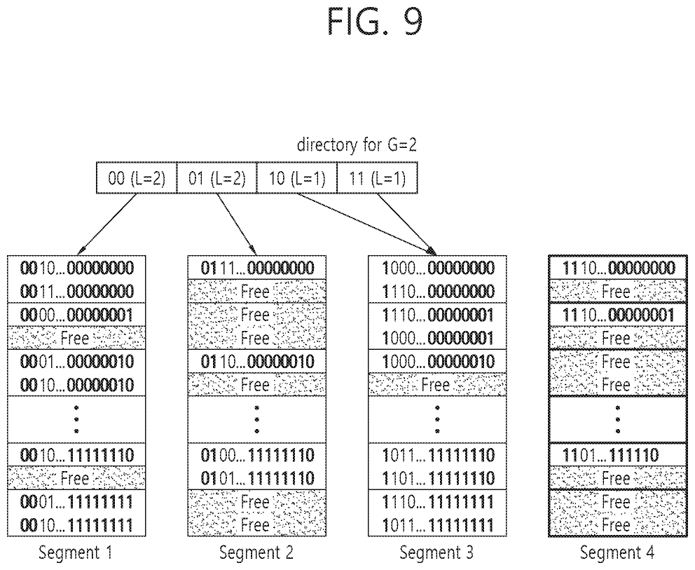

FIG. 9 illustrates an operation for creating a new segment in a cacheline conscious extendible hashing operation according to one embodiment of the present disclosure.

The next-generation persistent memory retains data therein even when the system crashes or power is turned off. If data are stored on such kind of persistent memory, the data need to be updated in an atomic manner so that the data may be accessed without a difficulty at system reboot.

The legacy disk-based extendible hashing schemes overwrite a large amount of data by performing a logging operation which generates a backup in a separate storage space when a bucket is split or a directory is updated.

The apparatus for CCEH according to one embodiment of the present disclosure may provide failure-atomic segment splits for persistent memories.

The apparatus for CCEH according to one embodiment of the present disclosure allocates a new segment when a segment is split and scans all the data stored in the segment. The local depth of the newly generated segment is one larger than the local depth of the split segment. Therefore, one bit of a hash key is further checked while the data in the split segment are scanned; if this bit is 1, the data are copied into the new segment while, if the bit is 0, the data are kept in the existing segment. It should be noted that even if data are copied to the new segment, they are not deleted from the existing segment. This is so intended to use the existing segment at the time of recovery.

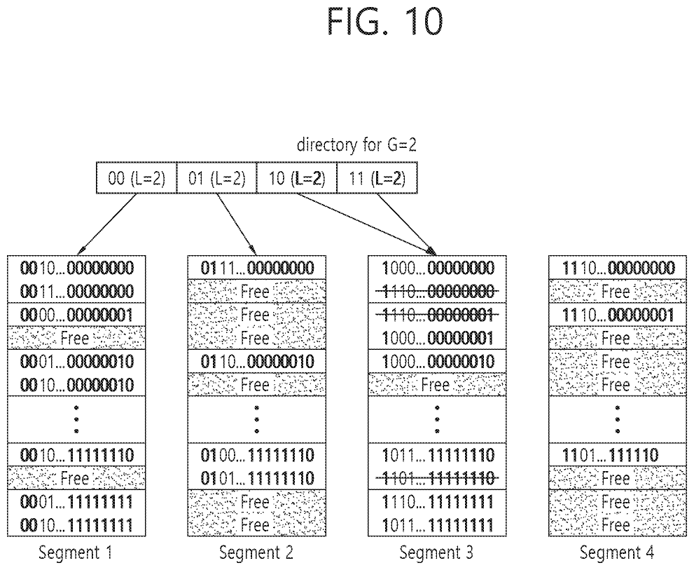

FIG. 9 shows a state where segment 3 of FIG. 8 having a local depth of 1 is split to create a new segment 4 having a local depth of 2. Even if the data copied from the existing segment to the new segment 4 are not deleted, they are considered to be invalid when the local depth of the segment is increased, and thus, it does not cause a problem if the data are left undeleted. For example, in FIG. 9, 1101 . . . 11111110₍₂₎ is copied to the segment 4 but still remains in the segment 3. However, as shown in FIG. 10, the data is considered to be invalid as soon as the local depth of the segment is increased, and the corresponding space may be used for storing other data.

FIG. 10 illustrates a split and lazy deletion operation in a cacheline conscious extendible hashing operation according to one embodiment of the present disclosure.

As shown in FIG. 10, although 1110 . . . 00000000₍₂₎, 1110 . . . 00000001₍₂₎, and 1101 . . . 111110₍₂₎ are copied to the segment 4 in FIG. 9, they are still left undeleted in the segment 3. This operation is referred to as lazy operation. As shown in FIG. 10, data migrated to the segment 4 but left undeleted in the segment 3 are considered to be invalid as soon as the local depth of the segment 3 is increased to 2, and the corresponding space may be used for storing other data.

The local depth of a segment split from an existing segment has to be increased after all of new segments are written. If this operating sequence is not maintained, a consistency problem may occur when the system crashes. After the local depth of the existing segment is increased, pointers of directory entries are updated, and the local depth of a split segment is increased. This operating sequence also needs to be maintained. FIG. 10 illustrates a state where the local depth of a split segment is increased, and the directory points to a new segment.

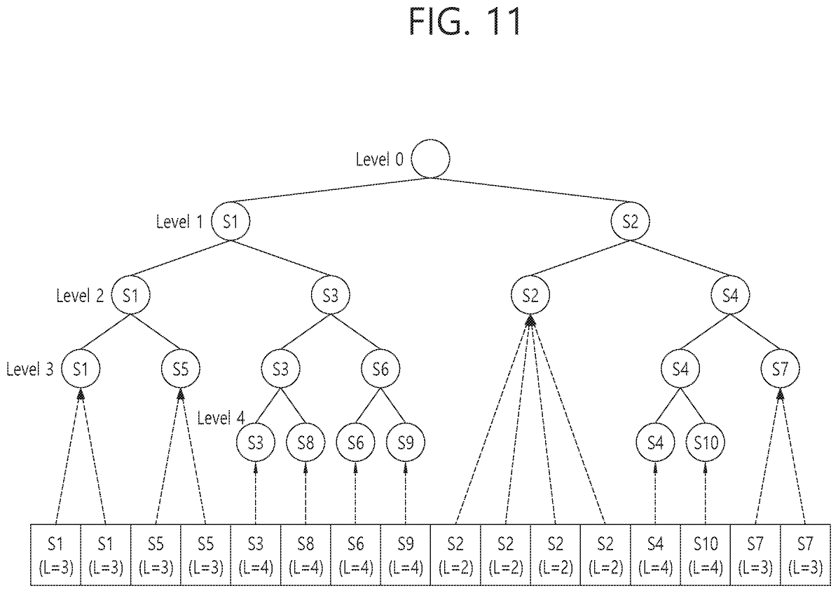

FIGS. 11 to 13 illustrate a tree-form segment split operation in a cacheline conscious extendible hashing operation according to one embodiment of the present disclosure.

If a segment is split, a number of directory entries in the directory need to be updated. In one embodiment of the present disclosure, when the directory is updated, directory entries are grouped into pairs, called buddy, to keep track of the segment split history in a tree form. In one embodiment of the present disclosure, if a problem occurs in the system, the problem may be discovered by traversing the tree. At this time, in one embodiment of the present disclosure, which part has caused the problem may be determined by using the global and local depths, and recovery may be proceeded by utilizing the buddy pair as a backup.

FIG. 11 shows a directory having 16 directory entries with the global depth of 4. The tree structure represents the segment split history. The figure shows that at first, only two segments, S1 and S2, exist in the CCEH structure. Eventually, S1 is split into S1 and S3, and S2 is split into S2 and S4. Also, at level 3, S1 is again split into S1 and S5; and S3 is split into S3 and S6. The current tree structure has a global depth of 4. Under this circumstance, suppose the segment S2 is split.

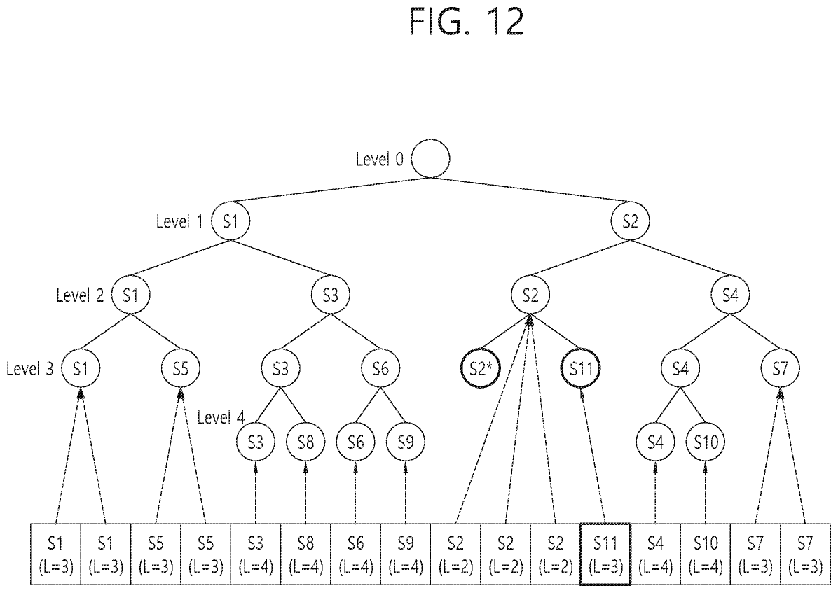

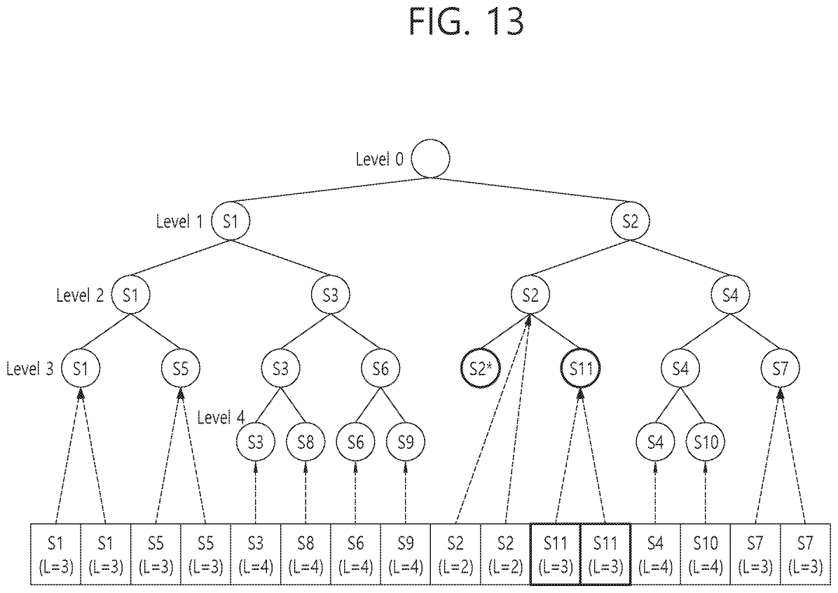

If S2 is split into S2 and S11, 9-th to 12-th directory entries have to be updated. When a number of directory entries are to be updated, the apparatus 100 for CCEH according to one embodiment of the present disclosure first updates an entry in the rightmost location and then updates entries located in the left one after another. As another example, when a number of directory entries are to be updated, the apparatus 100 for CCEH may first update an entry in the leftmost location and then update entries located in the right one after another. As shown in FIG. 12, the apparatus 100 for CCEH according to one embodiment of the present disclosure updates the 12-th S2 (L=2) to S11 (L=3). As shown in FIG. 13, the apparatus 100 for CCEH also updates the next, 11-th entry S2 (L=2) to S11 (L=3). Afterwards, the apparatus 100 for CCEH increases the local depths of the 10-th and 9-th entries by one and changes them to S2 (L=3). This ordering has to be preserved for recovery.

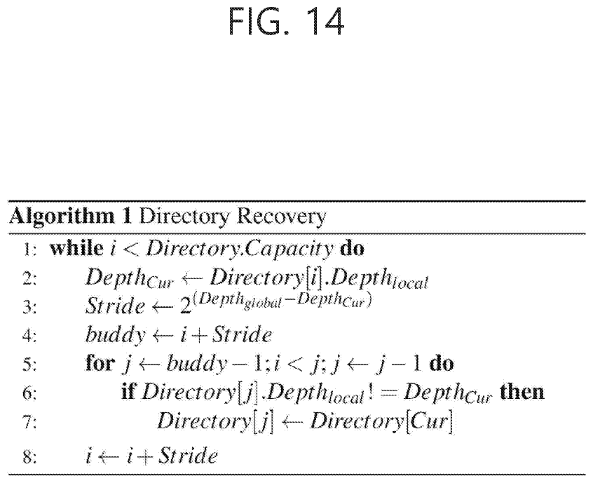

If system crashes while update is being progressed according to the order, the directory is updated through a recovery algorithm shown in FIG. 14 and recovered to the previous state guaranteeing consistency.

FIG. 14 illustrates a pseudo code of a recovery algorithm according to one embodiment of the present disclosure.

The recovery algorithm according to one embodiment of the present disclosure employs the condition that the characteristic due to operations performed according to the order as described above at the time of segment split and the local depth of a buddy segment always have to be maintained the same. If the local depth of a current segment is smaller than the local depth of a buddy segment in the right, it indicates that system has crashed while the segment is split. Therefore, by using the current node as a backup, the right segment is reconstructed. If the two local depths are the same with each other, it indicates that the buddy segment has been written completely.

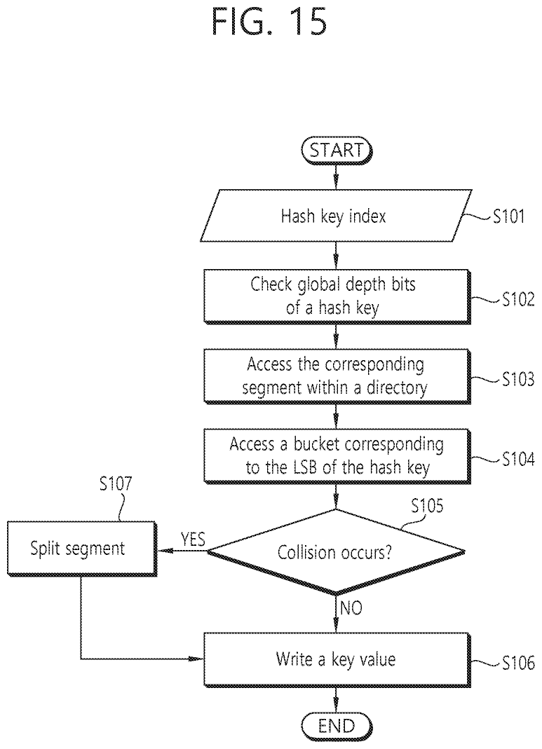

FIG. 15 is a flow diagram illustrating an insertion operation in a method for cacheline conscious extendible hashing according to one embodiment of the present disclosure.

In the S101 step, the apparatus 100 for CCEH according to one embodiment of the present disclosure receives an index of a hash key.

In the S102 step, the apparatus 100 for CCEH checks global depth bits of the received hash key.

In the S103 step, the apparatus 100 for CCEH accesses the corresponding segment within a directory by using the index of the hash key.

In the S104 step, the apparatus 100 for CCEH accesses a bucket corresponding to the LSB which is a bucket index of the hash key.

In the S105 step, the apparatus 100 for CCEH checks whether collision occurs.

In the S106 step, if collision does not occur, the apparatus 100 for CCEH writes a key value corresponding to the hash key.

In the S107 step, if collision occurs, the apparatus 100 for CCEH splits a segment in which the collision has occurred.

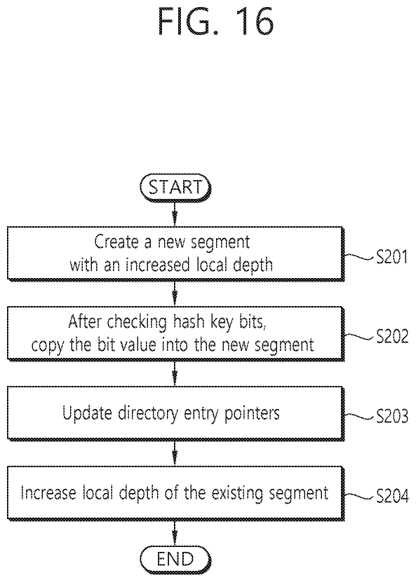

FIG. 16 is a flow diagram illustrating a split operation in a method for cacheline conscious extendible hashing according to one embodiment of the present disclosure.

In the S201 step, after starting segment split, the apparatus 100 for CCEH according to one embodiment of the present disclosure creates a new segment having an increased local depth.

In the S202 step, the apparatus 100 for CCEH checks the bits of the hash key and copies the bit value into the new segment.

In the S203 step, the apparatus 100 for CCEH updates pointers of directory entries.

In the S204 step, the apparatus 100 for CCEH increases the local depth of the existing segment.

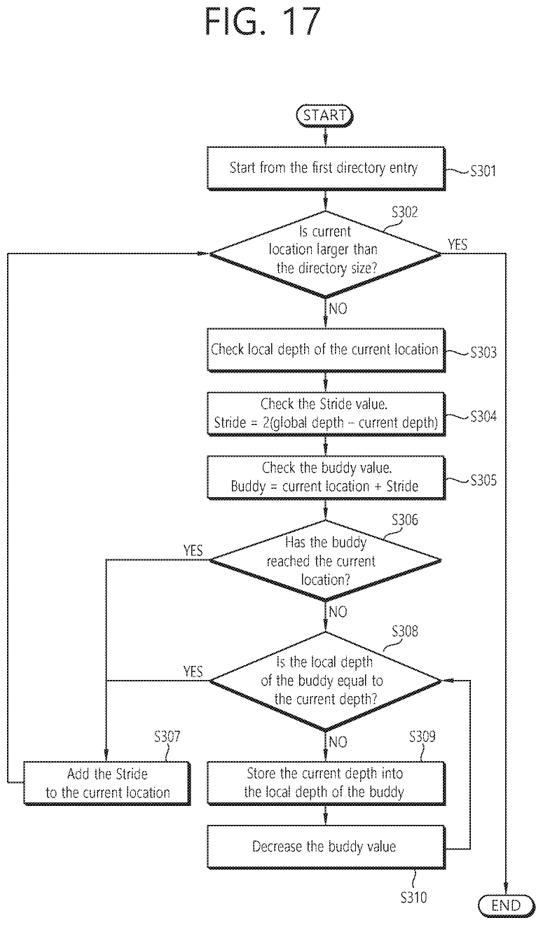

FIG. 17 is a flow diagram illustrating a recovery operation in a method for cacheline conscious extendible hashing according to one embodiment of the present disclosure.

In the S301 step, the apparatus 100 for CCEH according to one embodiment of the present disclosure starts the recovery operation from the first directory entry.

In the S302 step, the apparatus 100 for CCEH checks whether the current location is larger than the directory size.

In the S3030 step, if the current location is within the directory size, the apparatus 100 for CCEH checks the local depth of the current location. In the S302 step, if the current location is larger than the directory size, the apparatus 100 for CCEH terminates the recovery operation.

In the S304 step, the apparatus 100 for CCEH checks the stride. In other words, the apparatus 100 for CCEH determines the stride value as Stride=2 (global depth−current depth).

In the S305 step, the apparatus 100 for CCEH checks the buddy value. In other words, the apparatus 100 for CCEH checks the buddy value based on a relation that buddy=current location+Stride.

In the S306 step, the apparatus 100 for CCEH checks whether the buddy has reached the current location.

In the S307 step, if the buddy has reached the current location, the apparatus 100 for CCEH add the stride to the current location.

In the S308 step, if the buddy has not reached the current location, the apparatus 100 for CCEH checks whether the local depth of the buddy is equal to the current depth.

In the S309 step, if the local depth of the buddy is not equal to the current depth, the apparatus 100 for CCEH stores the current depth into the local depth of the buddy. On the other hand, if the local depth of the buddy is equal to the current depth, the apparatus for CCEH performs the S307 step.

In the S310 step, after storing the current depth into the local depth of the buddy, the apparatus 100 for CCEH decreases the buddy value. Then the apparatus 100 for CCEH performs the S308 step.

Now, experimental settings for embodiments of the present disclosure will be described.

To run an experiment for embodiments of the present disclosure, two Intel Xeon Haswell-EX E7-4809 v3 processors are used. The processor used for the experiment has 8 cores at 2.0 GHz, 8×32 KB instruction cache, 8×32 KB data cache, 8×256 KB L2 cache, and 20 MB L3 cache. And 64 GB of DDR3 DRAM and Quartz, DRAM-based PM latency emulator, have been used. To emulate write latency, stall cycles are inserted after each clflush instruction.

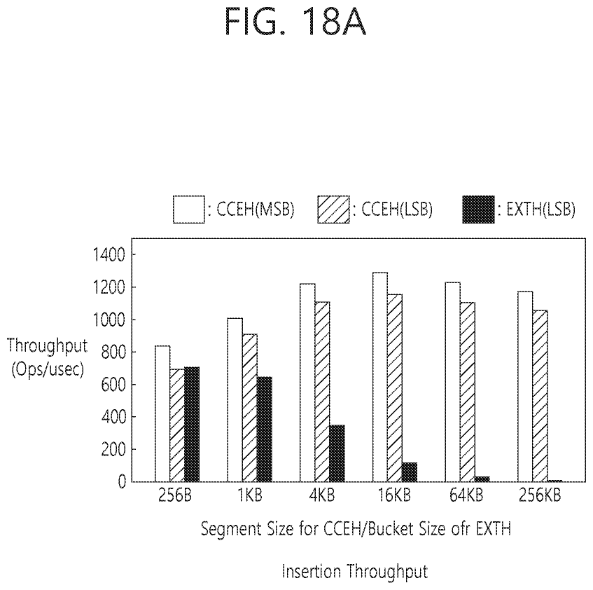

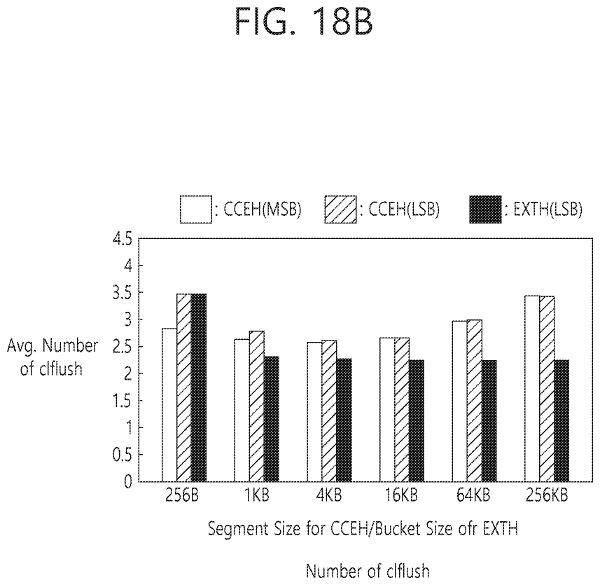

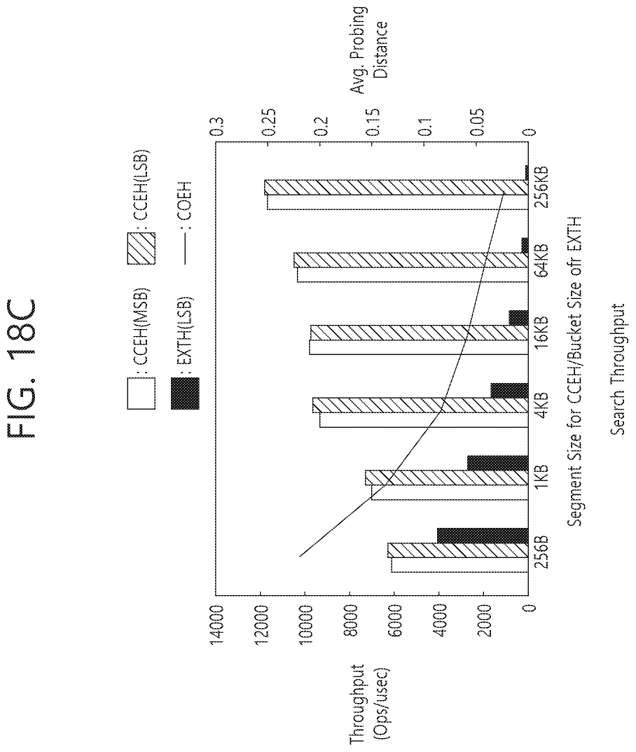

FIGS. 18A to 18C illustrate an experimental result of throughput with varying segment/bucket sizes between an embodiment of the present disclosure and the legacy method.

As shown in FIG. 18B, the legacy technique EXTH (LSB) less frequently splits a bucket as the bucket size is increased. However, as shown in FIGS. 18A and 18C, EXTH (LSB) reads a larger number of cachelines to search for an empty slot or record.

Since segment splits occur less frequently, the insertion throughput of CCEH (MSB) and CCEH (LSB) according to an embodiment of the present disclosure increases as the segment size is increased up to 16 KB. On the other hand, as shown in FIGS. 18A and 18C, the number of cachelines to read, namely. Last Level Cache (LLC) misses, is not affected by the large segment size.

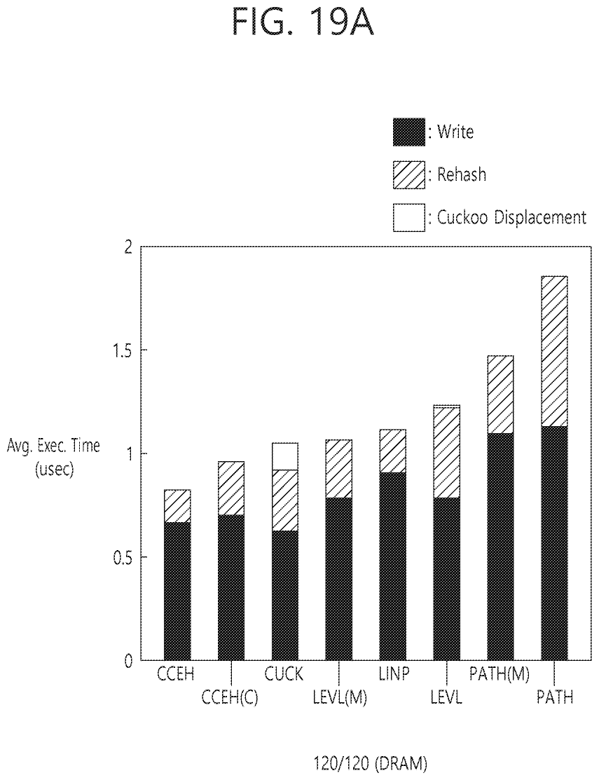

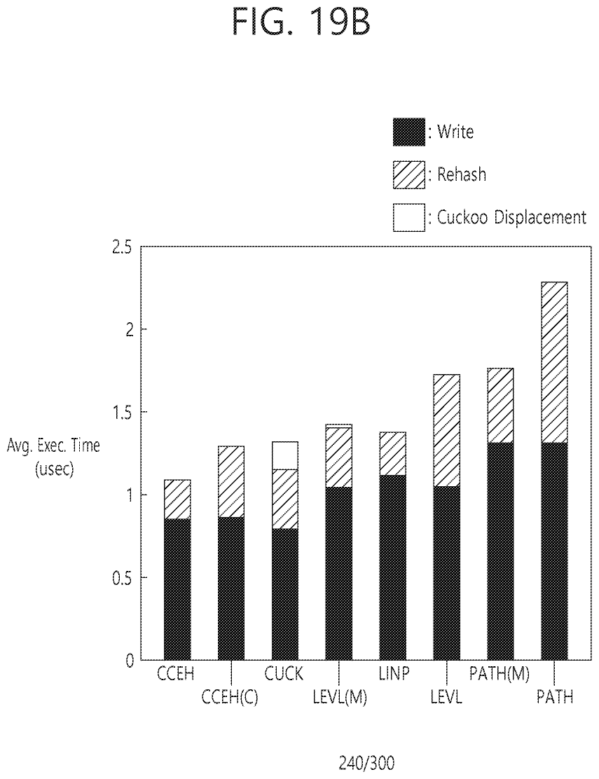

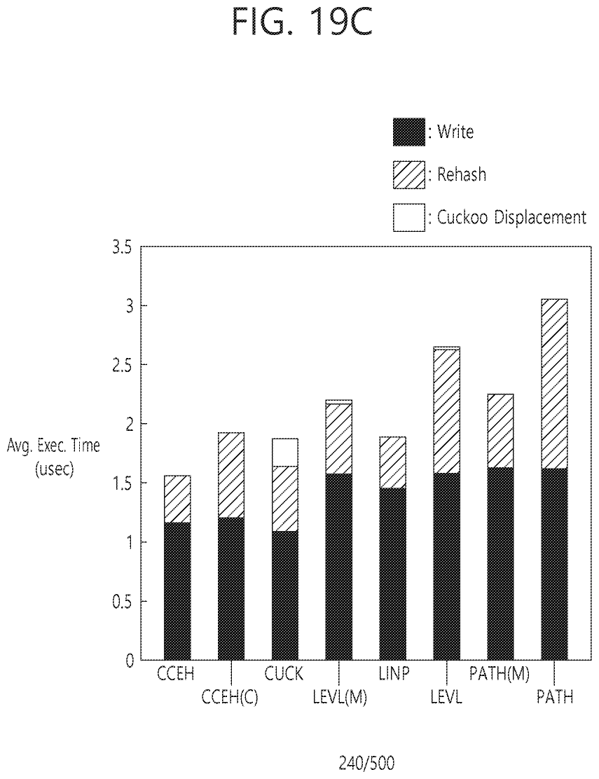

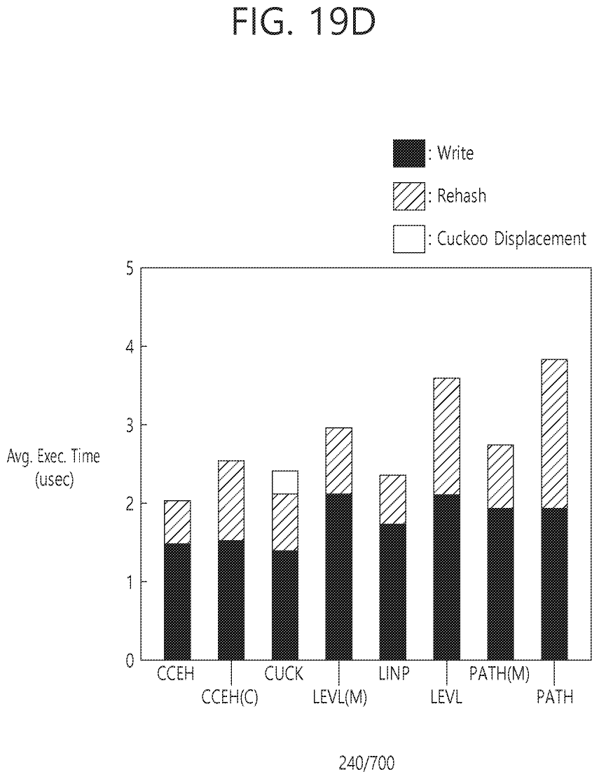

FIGS. 19A to 19D illustrate time spent for insertion with varying R/W latency of a non-volatile memory between an embodiment of the present disclosure and the legacy method.

In FIGS. 19A to 19D, Write denotes the bucket search and write time. Rehash denotes rehashing time. Cuckoo Displacement denotes the time to displace existing records to another bucket. As shown in FIGS. 19A to 19D, CCEH according to an embodiment of the present disclosure shows the fastest average insertion time throughout all read/write latencies.

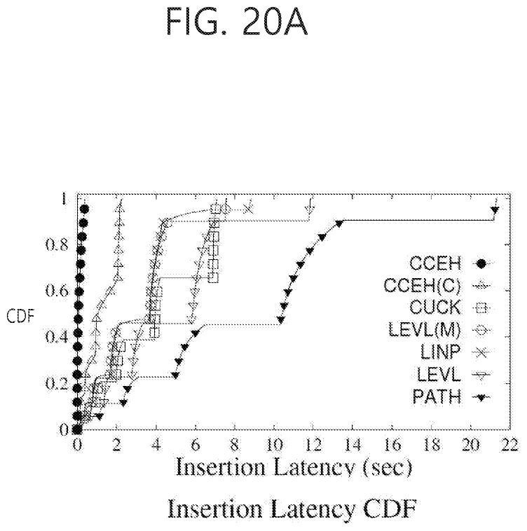

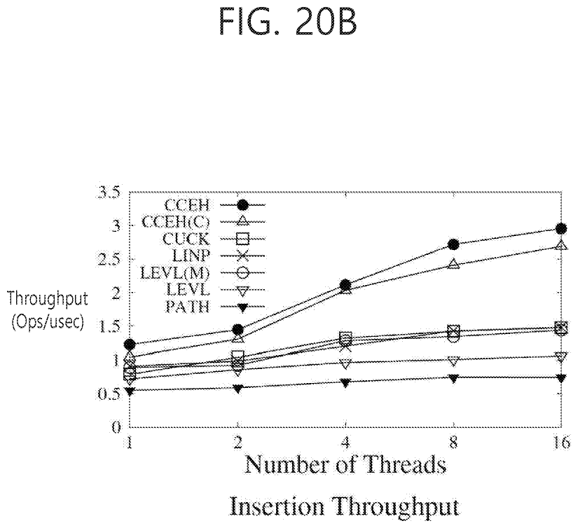

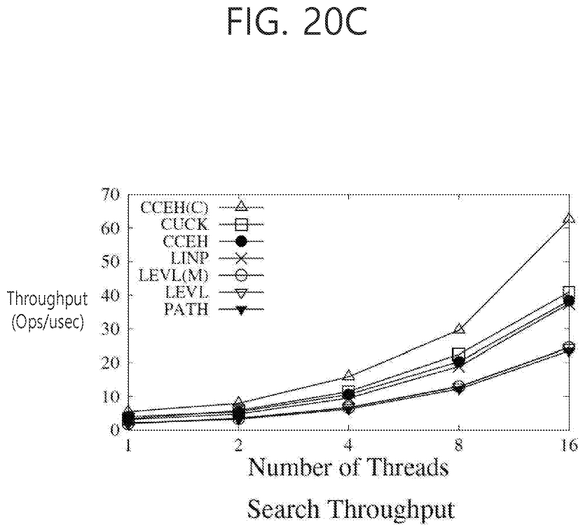

FIGS. 20A to 20C illustrate performance of concurrent execution indicated by latency CDFs and insertion/search throughput between an embodiment of the present disclosure and the legacy method.

As shown in FIGS. 20A to 20C, other implementation except for CCEH according to an embodiment of the present disclosure is affected by the full table rehashing overhead. CCEH(C) outperforms CCEH in terms of search throughput as in Copy-on-Write (CoW) lock free search. As shown in FIG. 20C, read transactions of CCEH(C) are non-blocking.

A method for CCEH according to embodiments of the present disclosure may be implemented as computer-readable code in a computer-readable recording medium. The method for CCEH according to embodiments of the present disclosure may be implemented in the form of program commands which may be executed through various types of computer means and recorded in a computer-readable recording medium.

As a non-volatile computer-readable storage medium including at least one program which may be executed by a processor, the non-volatile computer-readable storage medium including commands which instruct the processor to identify a segment referenced through a directory by using a first index of a hash key, identify a bucket to be accessed within the identified segment by using a second index of the hash key, and insert a key value corresponding to the hash key into the identified bucket may be provided when the at least one program is executed by the processor.

The method according to the present disclosure may be implemented in the form of computer-readable code in a recording medium that may be read by a computer. The computer-readable recording medium includes all kinds of recording media storing data that may be read by a computer system. Examples of computer-readable recording media include Read Only Memory (ROM), Random Access Memory (RAM), magnetic tape, magnetic disk, flash memory, and optical data storage device. Also, the computer-readable recording medium may be distributed over computer systems connected to each other through a computer communication network so that computer-readable code may be stored and executed in a distributed manner.

In this document, the present disclosure has been described with reference to appended drawings and embodiments, but the technical scope of the present disclosure is not limited to the drawings or embodiments. Rather, it should be understood by those skilled in the art to which the present disclosure belongs that the present disclosure may be modified or changed in various ways without departing from the technical principles and scope of the present disclosure disclosed by the appended claims below.

More specifically, the characteristic features described above may be executed by a digital electronic circuit, computer hardware, firmware, or a combination thereof. The characteristic features may, for example, be executed by a computer program product implemented within a storage apparatus of a machine-readable storage device so that they may be executed by a programmable processor. And the characteristic features may be executed by a programmable processor which executes a program of instructions for performing functions of the aforementioned embodiments as they are operated based on the input data to produce an output. The characteristic features described above may be executed within one or more computer programs which may be executed on a programmable system including at least one programmable processor, at least one input device, and at least one output device, which are combined to receive data and instructions from a data storage system and to transmit data and instructions to the data storage system. A computer program includes a set of instructions which may be used directly or indirectly within the computer to perform a specific operation with respect to a predetermined result. The computer program may be written by any one of programming languages including compiled or interpreted languages and may be used in any other form including a module, element, subroutine, other appropriate unit to be used in a different computing environment, or program which may be manipulated independently.

Processors appropriate for executing a program of instructions include, for example, both of general-purpose and special-purpose microprocessors, single processor, or multi-processors of a different type of computer. Also, storage devices appropriate for implementing computer program instructions and data which implement the characteristic features described above include all kinds of non-volatile storage devices: for example, semiconductor memory devices such as EPROM, EEPROM, and flash memory devices: internal hard disks; magnetic devices such as removable disks; optical magnetic disks; CD-ROM; and DVD-ROM disks. The processor and memory may be integrated within application-specific integrated circuits (ASICs) or added by the ASICs.

Although the present disclosure is described based on a series of functional blocks, the present disclosure is not limited to the embodiments described above and the appended drawings; rather, it should be clearly understood by those skilled in the art to which the present disclosure belongs that various substitutions, modifications, and variations of the present disclosure may be made without departing from the technical principles and scope of the present disclosure.

A combination of the aforementioned embodiments is not limited to the embodiments described above, but depending on implementation and/or needs, not only the aforementioned embodiments but also a combination of various other forms may be provided.

In the embodiments described above, methods are described according to a flow diagram by using a series of steps and blocks. However, the present disclosure is not limited to a specific order of the steps, and some steps may be performed with different steps and in a different order from those described above or simultaneously. Also, it should be understood by those skilled in the art that the steps shown in the flow diagram are not exclusive, other steps may be further included, or one or more steps of the flow diagram may be deleted without influencing the technical scope of the present disclosure.

The embodiments described above include examples of various aspects. Although it is not possible to describe all the possible combinations to illustrate the various aspects, it would be understood by those skilled in the corresponding technical field that various other combinations are possible. Therefore, it may be regarded that the present disclosure includes all of the other substitutions, modifications, and changes belonging to the technical scope defined by the appended claims.

What is claimed is:

1. A method for cacheline conscious extendible hashing performed by apparatus for cacheline conscious extendible hashing, the method comprising:
identifying a segment referenced through a directory by using a first index of a hash key;
identifying a bucket to be accessed within the identified segment by using a second index of the hash key; and
storing data corresponding to the hash key in the identified bucket.

2. The method of claim 1, further comprising checking global depth bits of the hash key.

3. The method of claim 1, wherein the first index of the hash key includes the most significant bit (MSB) of the hash key.

4. The method of claim 1, wherein the second index of the hash key includes the least significant bit (LSB) of the hash key.

5. The method of claim 1, wherein the identifying a segment searches for a directory entry corresponding to the first index of the hash key and identifies a segment referenced through the searched directory entry.

6. The method of claim 1, further comprising splitting a segment if collision occurs when the segment is accessed by using the second index of the hash key.

7. The method of claim 6, wherein the splitting a segment creates a new segment having an increased local depth and by scanning data of the identified segment, copies the data having a preconfigured bit value corresponding to the increased local depth into the newly created segment.

8. The method of claim 6, wherein the splitting a segment increases local depth of the split segment and designates data having a preconfigured, different bit value corresponding to the increased local depth as an invalid key.

9. The method of claim 6, wherein the splitting a segment increases local depth of the identified segment, updates a pointer of a directory entry, and increases local depth of the split segment.

10. The method of claim 6, if the segment is split, further comprising grouping directory entries into buddy pairs when the directory is updated.

11. The method of claim 10, further comprising identifying a segment exhibiting a system problem by using a global and local depths of the segment and recovering the segment exhibiting the system problem by using the buddy.

12. Apparatus for cacheline conscious extendible hashing comprising:
a memory storing at least one program and a segment including at least one bucket referenced through a directory; and
a processor connected to the memory through a cache,
wherein the processor is configured to execute the at least one program to
identify a segment referenced through a directory by using a first index of a hash key,
identify a bucket to be accessed within the identified segment by using a second index of the hash key, and
write or read data corresponding to the hash key to or from the identified bucket.

13. The apparatus of claim 12, wherein the processor further comprises checking global depth bits of the hash key.

14. The apparatus of claim 12, wherein the first index of the hash key includes the most significant bit (MSB) of the hash key.

15. The apparatus of claim 12, wherein the second index of the hash key includes the least significant bit (LSB) of the hash key.

16. The apparatus of claim 12, wherein the processor is configured to search for a directory entry corresponding to the first index of the hash key and identify a segment referenced through the searched directory entry.

17. The apparatus of claim 12, wherein the processor is configured to split a segment if collision occurs when the segment is accessed by using the second index of the hash key.

18. The apparatus of claim 17, wherein the processor is configured to create a new segment having an increased local depth and by scanning data of the identified segment, copy the data having a preconfigured bit value corresponding to the increased local depth into the newly created segment.

19. The apparatus of claim 17, wherein the processor is configured to increase local depth of the split segment and designate data having a preconfigured, different bit value corresponding to the increased local depth as an invalid key.

20. The apparatus of claim 17, wherein the processor is configured to increase local depth of the identified segment, update a pointer of a directory entry, and increase local depth of the split segment.
